(19) United States
(12) Patent Application Publication
(10) Pub. No.: US 2025/0298931 A1
(43) Pub. Date: Sep. 25, 2025

(54) METHOD OF PREDICTING PERFORMANCE OF A DRIVING MOTOR FOR A VEHICLE AND OPTIMIZING DESIGN PARAMETERS USING AI

(71) Applicants: HYUNDAI MOTOR COMPANY, SEOUL (KR); KIA CORPORATION, SEOUL (KR)

(72) Inventors: Dong-Chul Lee, Hwaseong-si (KR); Kyoung-Jin Noh, Hwaseong-si (KR); In-Soo Jung, Hwaseong-si (KR)

(73) Assignees: HYUNDAI MOTOR COMPANY, SEOUL (KR); KIA CORPORATION, SEOUL (KR)

(21) Appl. No.: 18/948,128

(22) Filed: Nov. 14, 2024

(30) Foreign Application Priority Data
Mar. 22, 2024 (KR) 10-2024-0039861

(51) Int. Cl. G06F 30/15

(52) U.S. Cl. CPC G06F 30/15

(57) ABSTRACT

An artificial intelligence (AI)-based motor development system for optimizing the design of a driving motor for a vehicle according to the present disclosure includes a prediction AI model generation part configured to predict motor performance improvement including noise/vibration/harshness (NVH), by fitting a polynomial curve to noise peak predictions, based on modified motor design variables obtained from the motor computer aided design (CAD) drawing. The system also includes a design parameter optimization AI model generation part configured to optimize motor design parameter dimensions from a design parameter optimization proposal AI model obtained through any one of reinforcement learning, Q-learning, and particle swarm optimization (PSO) using the prediction AI model as a feature extractor for target motor performance improvement.

### CROSS REFERENCE TO RELATED APPLICATIONS

This application claims priority to Korean Patent Application No. 10-2024-0039861, filed on Mar. 22, 2024, which is incorporated herein by reference in its entirety.

### BACKGROUND

### Technical Field

The present disclosure relates to the design of a driving motor for a vehicle. More specifically, the present disclosure relates to a method of predicting the performance of a driving motor for a vehicle and optimizing a motor design using artificial intelligence (AI).

### Description of Related Art

In general, motor computer aided design (CAD) is used to develop motors (i.e., driving motors) for a vehicle.

For example, a method for the development of a motor using CAD includes determining the design parameters of the motor (e.g., factors of a stator-rotor assembly), which can be configurable in motor CAD drawings. The method also includes analyzing all conditions of the correlation between the determined design parameters on a case-by-case basis. Additionally, the method may include predicting items for improvement in motor performance including noise/vibration/harshness (NVH) through simulations based on the analysis results. Thus, the motor development is completed by applying these findings to the dimensions of the motor design parameters.

Therefore, the method used for motor CAD development requires the generation and analysis of a simulation analysis model of the CAD motor drawing. To this end, it is very important to determine the motor design parameters, which serve as both analysis and design parameters for predicting the target performance of the motor.

However, in the motor CAD development method, specific units determined to be changeable based on a motor designer's experience are determined to be the motor design parameters. During generation of an analysis model, combinations of all parameters reflecting the correlations between the motor design parameters are often not included.

This limitation arises because the motor CAD development method cannot generate an analysis model reflecting all combinations of the motor design parameters due to time and cost constraints. Due to such limitations, the influence on some design parameters by which design may be changed is inevitably determined according to the motor designer's experience.

### SUMMARY

The present disclosure provides a motor design parameter optimization AI model capable of providing motor design parameters for achieving target performance. This is achieved by generating a motor performance prediction AI model through AI learning based on the motor design parameters from motor CAD drawings and data on motor performance. The model further applies reinforcement learning on the setting of target motor performance improvements by extracting features of the motor performance prediction AI model.

A method of predicting performance of a driving motor for a vehicle and optimizing design parameters using artificial intelligence (AI) includes acquiring data based on motor design parameters and motor performance of the driving motor mounted on the vehicle. The method also includes generating a motor performance prediction AI model from an automated machine learning (AutoML) part based on the acquired data on the motor design parameters and the motor performance. The method also includes applying an evolutionary algorithm to the motor performance prediction AI model and generating a motor design parameter optimization AI model through reinforcement learning.

In addition, target data of the motor performance prediction AI model may be motor performance and acquired through analysis of the motor design parameter.

In addition, combinations of the motor design parameters may be received through design of experience (DOE).

In addition, input data of the motor performance prediction AI model may be the motor design parameters. The motor design parameters may include any one or more of a slot, a tooth, a stator tooth, a bridge, a magnet, and a center post.

In addition, output data of the motor performance prediction AI model may be the motor performance, and the motor performance may include any one or more of noise/vibration/harshness (NVH), a torque, a torque ripple, and a magnetic flux.

In addition, the motor design parameter optimization AI model may use the motor performance, which is the output data of the motor performance prediction AI model, and have the motor design parameter, which is the input data of the motor performance prediction AI model, as output data.

In addition, the motor design parameter optimization AI model may adopt any one or more of reinforcement learning, Q-learning, and particle swarm optimization (PSO).

In addition, the motor design parameter optimization AI model may be calculated by a plurality of combinations of the optimized motor design parameters. A priority of the plurality of combinations of the optimized motor design parameters may be set under a restriction condition for the motor performance.

In addition, in the motor design parameter optimization AI model, when the target of the motor performance improvement is a reduction in NVH, a minimum change in torque may be set to a power performance restriction condition.

In addition, a noise level may be predicted from a machine learning (ML) model for the noise level in a process of optimizing the motor design parameter optimization AI model.

The method for optimizing the design of a driving motor for a vehicle using the AI-based motor development system according to the present disclosure, involves generating the optimized motor design parameter dimension group according to the target motor performance improvement. This is achieved through a performance prediction AI model that responds to a change in design parameters of vehicle motors, i.e., electric vehicle motors, and a design parameter optimization proposal AI model using the performance prediction AI model as a feature extractor.

It is possible to constitute the performance prediction AI model for performance prediction by labeling the NVH performance, magnetic force, torque ripple, and motor torque performance data according to the change in design parameters of the analysis simulation using the experimental radiation noise data and the CAD drawing data of the motor.

By using the performance prediction model according to the change in design parameters, it is possible to propose many combinations of design parameters with high probability of influence that can achieve the required target performance.

The Shapley additive explanation part (SHAP) function, which sorts features by descending order of importance, can be applied to ensure that the motor developer's domain knowledge aligns with the prediction model. This allows the performance prediction AI model to function as the feature extractor of the design parameter model, and provide a plurality of combinations of optimization design parameters for achieving the target performance.

The experimental and analytic results of the input data are labeled through the 2-step process. In particular, in the first step, the accurate performance of the performance prediction model with respect to various combinations of changes in design parameters can be predicted, and in the second step, the performance prediction AI model in the first step is used as one of the feature extractor. Many combinations of optimization design parameters for target performance with reinforcement learning can be proposed.

It is possible to validate the performance of the combination states of all motor design parameters and present realistic design parameters.

### BRIEF DESCRIPTION OF THE FIGURES

The above and other objectives, features, and other advantages of the present disclosure should be more clearly understood from the following detailed description when taken in conjunction with the accompanying drawings.

FIG. 1 is a configuration diagram of a method of predicting the performance of a driving motor for a vehicle and optimizing design according to an embodiment of the present disclosure.

FIG. 2 shows a prediction result data difference of a performance prediction AI model for each vehicle segment according to an embodiment of the present disclosure.

FIG. 3 is a conceptual diagram of a method of predicting the performance of a driving motor for a vehicle and optimizing design according an embodiment of the present disclosure on a step-by-step basis.

FIG. 4 is a flowchart of a method of deriving a motor design optimization model after a driving motor performance prediction AI model for a vehicle is generated according an embodiment of the present disclosure.

FIG. 5 is a conceptual diagram of a process of generating a driving motor performance prediction AI model for a vehicle according to an embodiment of the present disclosure.

### DETAILED DESCRIPTION

Hereinafter, embodiments of the present disclosure are described in detail with reference to the accompanying drawings. These embodiments are examples and can be implemented in various different forms by those having ordinary skill in the art to which the present disclosure pertains, and thus are not limited to embodiments disclosed herein.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

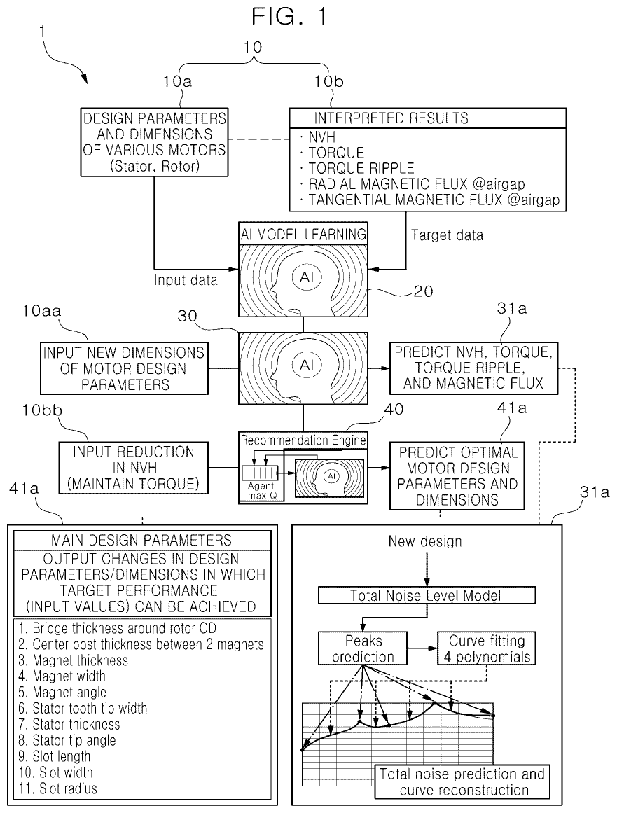

Referring to FIG. 1, a dataset used in the present disclosure includes motor design parameters 10a and motor performance 10b. The motor design parameters 10a may be provided from a motor computer aided design (CAD) drawing, and the motor performance may be provided from analysis (simulation) results calculated based on the motor design parameters.

The motor design parameters 10a are main design parameters of a stator/rotor assembly, which is a driving unit of a motor for an electric vehicle motor. In other words, in the present disclosure, as data for learning a driving motor performance prediction AI model for a vehicle, the motor design parameters 10a include dimensions of each of a stator and a rotor. The motor performance 10b includes analysis result values, such as a noise/vibration/harshness (NVH), a torque, a torque ripple, a radial magnetic flux, and a tangential magnetic flux, as target data.

More specifically, the motor design parameters 10a adopt a slot length, a slot radius, a tooth tip thickness, a tooth tip angle, a tooth width, a slot width, bridge thickness 1st/2nd layer, magnet thickness 1st/2nd layer, a center post thickness between two magnets, a center post thickness between two magnets 1st/2nd layer, a magnet angle, magnets 1st/2nd angle, magnet length 1st/2nd layer, a stator tooth width, and the like.

The motor design parameters may be acquired in a form of a combination of design parameters using design of experiment (DOE) and may also be applied by using data on competitors' motor specifications or adding new data.

For example, as the motor design parameters, data on 352 DOE points with respect to 11 motor design parameters including a bridge thickness around rotor outer diameter (OD), a center post thickness between two magnets, a magnet thickness/width/angle, a stator tooth tip width, a stator tooth thickness, a stator tip angle, and a slot length/width/radius may be acquired.

The motor performance 10b is the result of an analysis based on the dimensions assigned to the motor design parameters 10a. This target data represents motor performance, which is caused by the interaction between the rotor and the stator according to the motor design parameters 10a.

In this case, the motor performance 10b includes NVH, a torque ripple, a torque ripple harmonics order, a radiated power order, max density of stator, a noise level, a noise area, a peak number, a peak torque, a shaft speed, and the like.

The driving motor performance prediction AI model for a vehicle is generated from an AI model learning part 20 by having the motor design parameters 10a as input data and the motor performance 10b as target data.

A driving motor performance prediction AI model 30 for a vehicle, trained by the AI model learning part 20, predicts performance result data 31a based on changes in the motor design parameters 10aa. When new dimensions are applied to the motor design, replacing the original motor design parameters 10a, the model generates updated performance predictions.

For example, the motor design parameters 10aa changed to the new dimensions is a design parameter that represents the main performance of the motor and may be applied by changing the slot length/width, the tooth tip thickness/angle, the bridge thickness 1st/2nd layer, the magnet thickness/length 1st/2nd layer, the magnet angle, center post thickness between two magnets, the stator tooth tip width, and the like.

The driving motor performance prediction AI model 30 for a vehicle generated by the AI model learning part 20 is provided to be a motor performance prediction AI model of which correlation, which is a change in performance based on changes in motor design parameters, is set to be higher than 0.95.

In addition, a design parameter optimization AI model 40 may be generated from the driving motor performance prediction AI model 30 for a vehicle generated by the AI model learning part 20. Hereinafter, the driving motor performance prediction AI model for a vehicle may be referred to as a motor performance prediction AI model.

The motor performance prediction AI model is generated by setting n points representing an operating area of an electric vehicle motor, acquiring main performance result data from n points, then using the same as input data and target data, and performing learning to have correlation in which the accuracy of the motor performance on the motor design parameters is 95% or higher.

By operating an electric power supply by the current driving from the input and target data obtained through test or calculation, a process of sequentially calculating performance of an electromagnetic system by an electromagnetic force, a mechanical system by a velocity, an acoustic environment by acoustic noise, and the like is performed in the motor performance prediction AI model.

In particular, the performance of the electromagnetic system is calculated in combination of any one or more of airgap force calculation, a Maxwell stress tensor method, and Fourier analysis as a FE-based model. The performance of the mechanical system is calculated in a combination of any one or more of analytical based models, a free motion response, and a force response. The performance of the acoustic noise is calculated in a combination of any one or more of analytical based models and sound power levels.

The motor performance prediction AI model 30 may have improved reliability compared to the conventional model of predicting performance depending on the domain knowledge result of the motor developer.

AI model generated by the AI model learning part 20 is stored and provided may be referred to as the motor performance prediction AI model 30 to improve reliability. A place where the motor performance prediction AI model 30 is provided or stored may be referred to as the motor performance prediction AI model generation part.

The AI model generated by motor performance prediction AI model 30 is stored and may be referred to as the design parameter optimization AI model 40 to optimize design parameters. A place where the design parameter optimization AI model 40 is provided or stored may be referred to as the design parameter optimization AI model generation part.

The design parameter optimization AI model 40 provides a design parameter optimization AI model which can predict optimized motor design parameters and dimensions 41a with respect to the input of target performance for motor performance improvement including a reduction in NVH 10bb based on the motor performance prediction AI model 30 with improved reliability.

In other words, in the design parameter optimization AI model generation part, the target performance of the motor including NVH is input data, the motor design parameters are output data, and as an AI recommendation algorithm, reinforcement learning, Q-learning, and particle swarm optimization (PSO) are combined or selectively applied so that input/output are set opposite to the motor performance prediction AI model.

In other words, through the AI recommendation algorithm, a design parameter optimization proposal AI model that has changes in design parameters and dimension output that can achieve the target performance of the motor performance improvement including NVH may be provided.

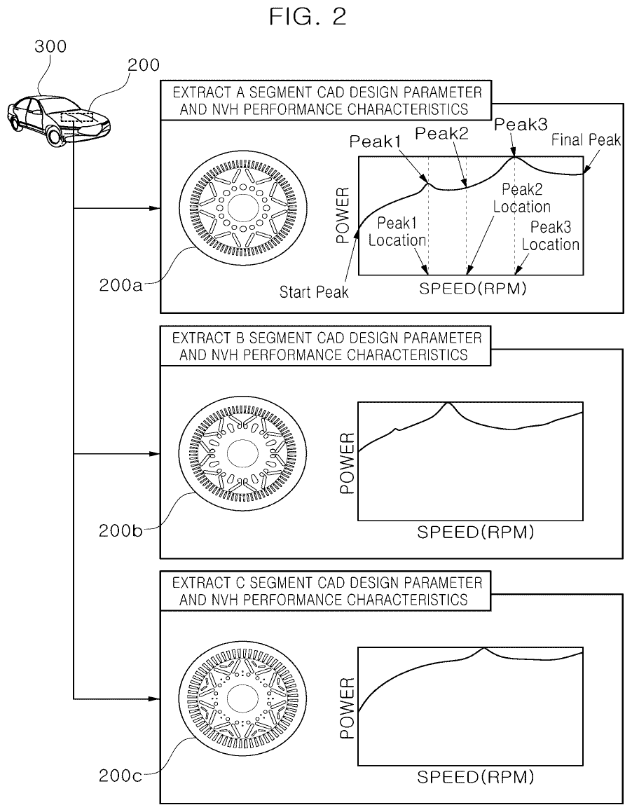

Referring to FIG. 2, motor design parameters and performance data of the motor 200 are acquired from a vehicle 300 for each segment classified based on the overall length (length from a front bumper to a rear bumper) and price of the vehicle.

For example, an A type motor 200a is an example in which motor design parameters and NVH performance characteristics suitable for an A segment vehicle are extracted. A B type motor 200b is an example in which motor design parameters and NVH performance characteristics suitable for a B segment vehicle are extracted. A C type motor 200c is an example in which motor design parameters and NVH performance characteristics suitable for a C segment vehicle are extracted. The motor design parameters and motor performance including NVH of the A, B, and C type motors may each be used as data acquired for modeling as input data and target data or may each be used as input data of an established model.

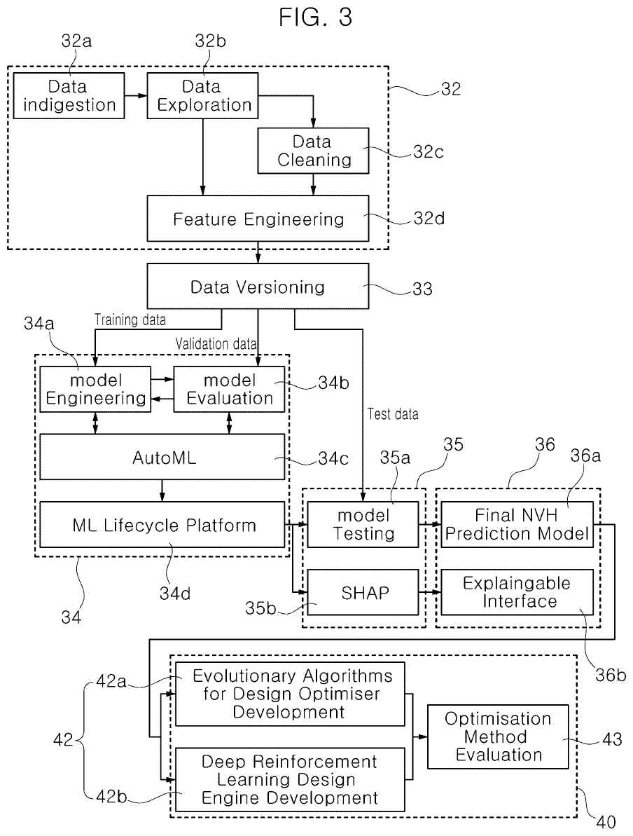

FIGS. 1 and 3 are a detailed configuration for generating the performance prediction AI model and the design parameter optimization AI model of the AI model learning part 20. FIGS. 1 and 3 show a conceptual diagram of a method of predicting the performance and optimizing the design of the driving motor for a vehicle on a step-by-step basis.

Specifically, the motor performance prediction AI model 30 generated by the AI model learning part 20 may be provided through a data acquisition part 32, a data versioning 33, a model generation part 34, a model test evaluation part 35, and a performance prediction model finishing part 36.

For example, the data acquisition part 32 of the learning model uses the motor design parameters as input data. The motor design parameters used as the input data include the motor design parameters and dimensions thereof.

Experimental labeling values or simulation (analysis) labeling values with respect to the motor design parameters are obtained as target data, and learning model data of which features are extracted by a data selection process through outer-line data analysis of the labeling values is selected.

The learning model data acquisition part 32 includes a data indigestion part 32a including massive experimental and analytic labeling values representing performance for each motor design parameter. The learning model data acquisition part 32 also includes: a data exploration part 32b for inquiring and analyzing the acquired data including the massive experimental and analytic labeling values and deriving useful information; a data cleaning part 32c for identifying, modifying, and filtering errors, missing, and inaccurate values of the dataset; and a feature engineering part 32d for optimizing the characteristics of the outer-line data between the experimental labeling value and the simulation (analysis). Additionally, the feature engineering part 32d is configured to extract features as the useful information to finally acquire learning model data to be used.

The data versioning 33 manages data versions of the pre-acquired data and newly-acquired dataset with respect to the motor design parameters and performance that have been used for learning and performs systematic model management with an index configuration of data amplification.

The data versioning 33 provides training data and validation data from the data acquired for the model generation part 34 and provides test data for model evaluation in the model test evaluation part 35.

The model engineering part 34a of the model generation part 34 uses the training data for model generation and establishes a machine learning model by automating a process of developing the machine learning model by an automated machine learning (AutoML) part 34c.

The established machine learning model is validated by the model evaluation part 34b using validation data provided from the data versioning 33.

The model generation part 34 is performed based on an ML lifecycle platform 34d in addition to all of the model engineering part 34a, the model evaluation part 34b, and the AutoML part 34c. The ML lifecycle platform 34d is a total solution for supporting the development, distribution, monitoring, and maintenance of the machine learning model.

The model generation part 34 uses the motor design parameters as input data for the motor performance prediction AI model and has the motor performance as output data, and establishes a model that combines a deep neural network structure to increase the accuracy for output data of the model compared to actual performance.

In particular, the model engineering part 34a and the model evaluation part 34b increase the correlation between the performance of the training model and the validation model through mutual data exchange and validation. Additionally, the AutoML part 34c increases the correlation of the performance for the performance prediction model through data exchange and validation between the model engineering part 34a and the model evaluation part 34b.

The model test evaluation part 35 evaluates the performance prediction model of the AutoML part 34c with the sensitivity analysis of a change in performance based on a change in model design parameter (i.e., dimensions) and visualization for the result as the test data. Furthermore, the model test evaluation part 35 compares the test data with a developer's domain knowledge result. As a result, the model test evaluation part 35 improves reliability compared to the performance prediction AI model.

To this end, the model testing part 35a of the model test evaluation part 35 applies the test data to the performance prediction model and tests the accuracy of the model.

The Shapley additive explanation part (SHAP) 35b of the model test evaluation part 35 is a statistical technique and framework for interpreting and explaining the prediction of the machine learning model. The SHAP 35b is used to evaluate how much a predicted value contributes to certain characteristics or elements to help analyze the prediction of the model.

The performance prediction model finishing part 36 finalizes the performance prediction model 36a and receives an explainable interface from the SHAP part 35b in an explainable interface part 36b.

The design parameter optimization AI model generation part 40 extracts the features of the design parameter optimization AI model 40 from the motor performance prediction AI model 30 finalized by a final NVH prediction model part 36a. The final design parameter optimization AI model 40 uses the target performance of the motor as the input data and has the motor design parameter for target performance as the output data.

A reinforcement learning technique is applied to the design parameter optimization AI model, and the features of the motor performance prediction AI model are extracted through the optimization. The design parameter optimization AI model generation part 40 is classified into an evolutionary algorithm for design optimizer development part 42a and a deep reinforcement learning design engine development 42b. The performance prediction model is finally used as the feature extractor in an optimization method evaluation part 43.

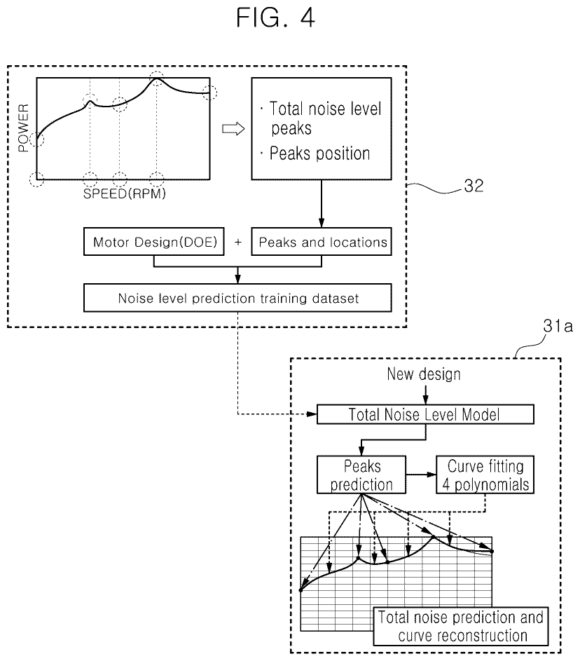

FIG. 4 shows an example in which NVH is applied as the motor performance, and a training dataset including a peak value and peak location of the overall noise level as the motor performance with respect to the motor design parameters to which the motor design DOE is applied is acquired by the data acquisition part 32 to generate an overall noise level model as the motor performance prediction AI model. The peak prediction of the noise is output as curve fitting 4 polynomials from the overall noise level model.

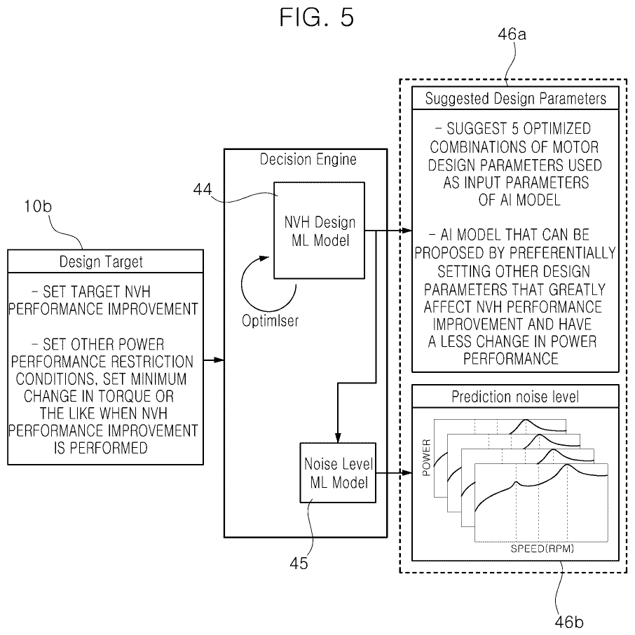

FIG. 5 shows a process of deriving the motor design parameter optimization AI model with respect to NVH as the motor performance. In the motor design parameter optimization AI model, when the target of the motor performance improvement is a reduction in NVH, a minimum change in torque is set to a power performance restriction condition.

Therefore, when the NVH improvement performance is input as a target under the condition in which the change in torque is minimum while the NVH performance is being improved, an optimal motor design parameter for achieving the motor performance improvement target is output. To derive the optimization model capable of achieving the same, any one or more of Q-learning and particle swarm optimization (PSO) is applied, and an NVH design ML model 44 is optimized to achieve the motor performance with the correlation of 95% or more with respect to the motor design parameters. The NVH design ML model is confirmed as the design parameter optimization proposal AI model when reaching the motor performance improvement target including NVH, and the motor design parameter is output.

The motor design parameter optimization AI model calculates n combinations of design parameters 46a. In addition, the priority of the n combinations of motor design parameters is set under the restriction condition for the motor performance.

In other words, in the optimization model, the n combinations of motor design parameters and dimensions are suggested, thereby greatly affecting the NVH performance improvement. The design parameter in which the change in torque as the power performance is minimum is set to the priority of the output data.

Noise levels for n combinations 46b may be predicted from a noise level ML model 45 with respect to noise levels determined from the optimized NVH design ML model 44.

In other words, by repeatedly performing the NVH design and the noise level ML model while deriving the optimized NVH design ML model 44 and noise level ML model 45 from the optimized design parameter AI model generation part 40, the optimization for the NVH design ML model and the noise level is performed to reach the target NVH performance improvement.

1. A method of predicting performance of a driving motor for a vehicle and optimizing design parameters using artificial intelligence (AI), the method comprising:
acquiring data based on motor design parameters and motor performance of the driving motor mounted on the vehicle;
generating a motor performance prediction AI model from an automated machine learning (AutoML) part based on the acquired data on the motor design parameters and the motor performance;
applying an evolutionary algorithm to the motor performance prediction AI model; and
generating a motor design parameter optimization AI model through reinforcement learning.

2. The method of claim 1, wherein target data of the motor performance prediction AI model is motor performance and wherein the target data is acquired through analysis of the motor design parameters.

3. The method of claim 1, wherein combinations of the motor design parameters are received through design of experience (DOE).

4. The method of claim 1, wherein input data of the motor performance prediction AI model is the motor design parameters, and wherein the motor design parameters include any one or more of a slot, a tooth, a stator tooth, a bridge, a magnet, and a center post.

5. The method of claim 1, wherein output data of the motor performance prediction AI model is the motor performance, and wherein the motor performance includes any one or more of noise/vibration/harshness (NVH), a torque, a torque ripple, and a magnetic flux.

6. The method of claim 1, wherein the motor design parameter optimization AI model uses the motor performance, which is output data of the motor performance prediction AI model, and has the motor design parameter, which is input data of the motor performance prediction AI model, as output data.

7. The method of claim 6, wherein the motor design parameter optimization AI model adopts any one or more of reinforcement learning, Q-learning, and particle swarm optimization (PSO).

8. The method of claim 6, wherein the motor design parameter optimization AI model is calculated by a plurality of combinations of the optimized motor design parameters, and wherein a priority of the plurality of combinations of motor design parameters is set under a restriction condition for the motor performance.

9. The method of claim 6, wherein, in the motor design parameter optimization AI model, when a target of the motor performance improvement is a reduction in noise/vibration/harshness (NVH), a minimum change in torque is set to a power performance restriction condition.

10. The method of claim 6, wherein a noise level is predicted from a machine learning (ML) model for the noise level in a process of optimizing the motor design parameter optimization AI model.
